(19) United States
(12) Patent Application Publication
(10) Pub. No.: US 2007/0174383 A1
(43) Pub. Date: Jul. 26, 2007

(54) System and method for effectively configuring a marketsite application integrator

(75) Inventors: Richard L. Denoix, Pleasanton, CA (US); Carsten Blecken, Mountain View, CA (US); Jayaram Rajan Kasi, San Jose, CA (US); Jong Hwan Park, Campbell, CA (US); Gary H. Yue, San Jose, CA (US); Steve Cheng, Milpitas, CA (US); Changzhong Tong, Pleasanton, CA (US)

Correspondence Address: HAYNES BEFFEL & WOLFELD LLP, P O BOX 366, HALF MOON BAY, CA, 94019, US

(73) Assignee: Open Invention Network LLC, Pound Ridge, NY (US)

(21) Appl. No.: 11/725,092

(22) Filed: Mar. 16, 2007

Related U.S. Application Data
(63) Continuation of application No. 10/302,327, filed on Nov. 22, 2002.
(60) Provisional application No. 60/339,592, filed on Dec. 11, 2001.

(51) Int. Cl. G06F 15/16

(52) U.S. Cl. 709/200; 715/700

(57) ABSTRACT

A system and method for effectively configuring a marketsite application integrator may include an application program running on a computer device that is coupled through a computer network to other 10 electronic entities for performing various types of electronic commercial transactions. An application integrator may be coupled to the application program for providing incoming data from a data source to the application program. The application integrator may also provide outgoing data from the application program to a data destination. The application integrator may 15 include various configurable integrator modules for selectively processing the incoming data and outgoing data in an appropriate and effective manner.

### PRIORITY INFORMATION

This application is a continuation of U.S. application Ser. No. 10/302,327, entitled “System and Method for Effectively Configuring a Marketsite Application Integrator” filed on Nov. 22, 2002, which application claims priority to U.S. Provisional Application Ser. No. 60/339,592, entitled “System And Method For Effectively Implementing A Marketsite Application Integrator” that was filed on Dec. 11, 2001.

### BACKGROUND SECTION

1. Field of the Invention

This invention relates generally to techniques for managing electronic information, and relates more particularly to a system and method for effectively configuring a marketsite application integrator.

2. Description of the Background Art

Implementing effective methods for managing electronic information is a significant consideration for designers and manufacturers of contemporary electronic devices. However, effectively managing information utilized by electronic devices may create substantial challenges for system designers. For example, enhanced demands for increased device functionality and performance may require more system processing power and require additional hardware resources. An increase in processing or hardware requirements may also result in a corresponding detrimental economic impact due to increased production costs and operational inefficiencies.

Furthermore, enhanced device capability to perform various advanced management operations may provide additional benefits to a system user, but may also place increased demands on the control and management of various device components. For example, an enhanced electronic device that effectively transfers and manipulates digital data may frequently benefit from an efficient implementation because of the large amount and complexity of the digital data involved.

Due to growing demands on system resources and substantially increasing data magnitudes, it is apparent that developing new techniques for information management is a matter of concern for related electronic technologies. Therefore, for all the foregoing reasons, developing effective systems for managing information remains a significant consideration for designers, manufacturers, and users of contemporary electronic systems.

### SUMMARY

In accordance with the present invention, a system and method for effectively configuring a marketsite application integrator is disclosed. In one embodiment, the present invention may include an application program running on a computer device that is coupled through a computer network to other electronic entities for performing various types of electronic commercial transactions.

In accordance with certain embodiments of the present invention, an application integrator may be coupled to the foregoing application program for effectively providing incoming data from one or more data sources to the application program. The application integrator may also effectively provide outgoing data from the application program to one or more data destinations. The application integrator may advantageously include various configurable integrator modules for selectively processing the incoming data and outgoing data in an appropriate and effective manner.

The foregoing integrator modules may be configurably organized as a module pipeline that may include either a linear or a non-linear inbound pipeline for selectively processing the incoming data. The foregoing module pipeline may also include either a linear or a non-linear outbound pipeline for selectively processing the outgoing data. In addition, the application integrator may include appropriate module interfaces with various contracts that permit corresponding integrator modules to be plugged into an integrator framework of the application integrator.

In certain embodiments, the foregoing module pipeline may include a connector messaging service module, a multiplexer module, an error module, a forming module, an authentication module, a version transformation module, a content transformation module, a dispatch module, and a component model module. The present invention thus provides an improved system and method for effectively configuring a marketsite application integrator.

### BRIEF DESCRIPTION OF THE DRAWINGS

FIG. 1A is a block diagram of an electronic network, in accordance with one embodiment of the present invention;

FIG. 1B is a block diagram of another electronic network, in accordance with one embodiment of the present invention;

FIG. 2 is a block diagram for one embodiment of a computer from

FIG. 3 is a block diagram for one embodiment of the memory of FIG. 2, in accordance with the present invention;

FIG. 4 is a block diagram for one embodiment of the MA1 of FIG. 3, in accordance with the present invention;

FIG. 5 is a block diagram for one embodiment of the MA1 framework of FIG. 4, in accordance with the present invention;

FIG. 6 is a block diagram illustrating a message transfer procedure for the modules of FIG. 4, in accordance with one embodiment of the present invention;

FIG. 7 is a block diagram for one embodiment of the module interfaces of FIG. 4, in accordance with the present invention;

FIG. 8A is a block diagram for one embodiment of a linear module pipeline, in accordance with the present invention;

FIG. 8B is a block diagram for one embodiment of a non-linear module pipeline, in accordance with the present invention;

FIG. 9 is a block diagram for one embodiment of a configuration GUI, in accordance with the present invention;

FIG. 10 is a block diagram illustrating a module wrapper, in accordance with one embodiment of the present invention;

FIG. 11 is a flowchart of method steps for performing a default inbound message procedure, in accordance with one embodiment of the present invention; and

FIG. 12 is a flowchart of method steps for performing a default outbound message procedure, in accordance with one embodiment of the present invention.

### DETAILED DESCRIPTION

The present invention relates to an improvement in information management techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for effectively configuring a marketsite application integrator, and may include an application program running on a computer device that is coupled through a computer network to other electronic entities for performing various types of electronic commercial transactions. An application integrator may be coupled to the application program for providing incoming data from a data source to the application program. The application integrator may also provide outgoing data from the application program to a data destination. The application integrator may include various configurable integrator modules for selectively processing the incoming data and outgoing data in an appropriate and effective manner.

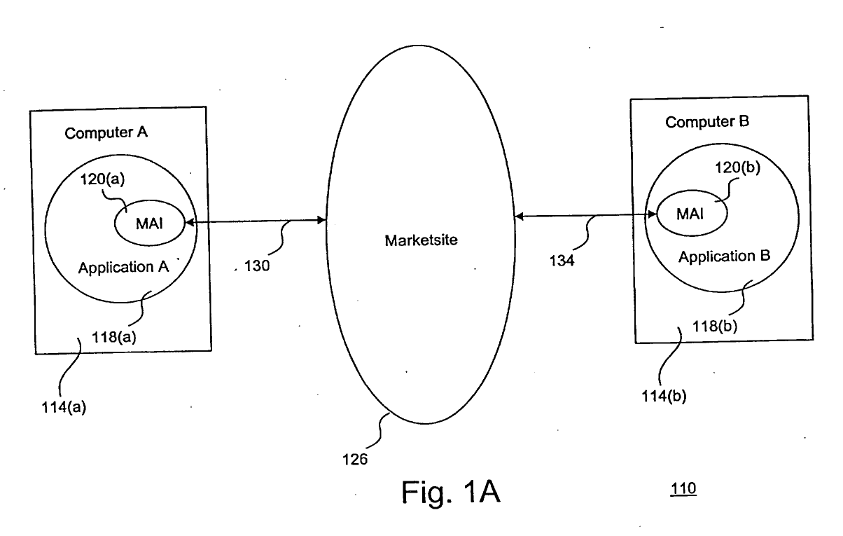

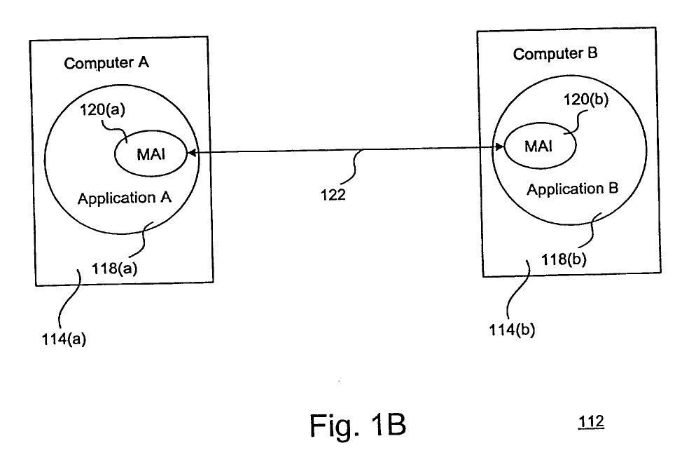

Referring now to FIG. 1A, a block diagram of an exemplary electronic network 110 is shown, in accordance with one embodiment of the present invention. In the FIG. 1A embodiment, electronic network 110 may preferably include, but is not limited to, a computer A 114(a), a computer B 114(b), and a marketsite 126. In alternate embodiments, electronic network 110 may readily be implemented using various components and configurations in addition to, or instead of, those discussed in conjunction with the FIG. 1A embodiment. For example, electronic network 110 may typically include any number of computers 114 that are connected through market site 126 or in any other appropriate manner.

In the FIG. 1A embodiment, marketsite 126 may preferably include one or more centrally-coupled computer systems or other electronic devices that support various types of electronic commercial transactions between different interested parties coupled to electronic network 110. In the FIG. 1A embodiment, marketsite 126 may preferably include appropriate transaction engine software for conducting the foregoing electronic commercial transactions. In certain embodiments, marketsite 126 may also provide various other types of transaction support services. For example, marketsite 126 may include various types of billing services, message routing mechanisms, directories, repositories, and communication gateways.

During the operation of certain embodiments of electronic network 110, a first trading partner may preferably utilize computer A 114(a) to bi-directionally exchange electronic messages with a second trading partner through marketsite 126 and computer B 114(b). For example, an application A 118(a) of computer A 114(a) may preferably prepare and send messages through a local marketsite application integrator (MAI) 120(a) to computer B 114(b) via path 130, marketsite 126, and path 134. In response, computer B 114(b) may preferably utilize a local MA1 120(b) to receive the messages sent from computer A 114(a), and provide the messages to an application B 118(b) for appropriate action.

Similarly, an application B 118(b) of computer B 114(b) may preferably prepare and send messages through MA1 120(b) to computer A 114(a) via path 134, marketsite 126, and path 130. In response, computer A 114(a) may preferably utilize MA1 120(a) to receive the messages sent from computer B 114(b), and provide the received messages to application A 118(a) for appropriate action.

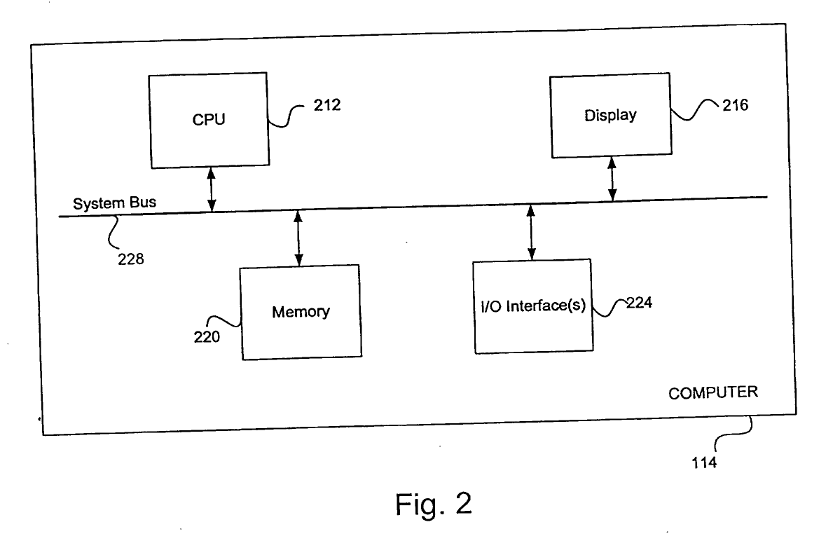

In certain embodiments of the present invention, MA1 120 may preferably be implemented to be embeddable into any desired type of computer environment or server technology running JAVA. Furthermore, in certain embodiments, the environment that hosts a MA1 120 may preferably support the execution of JAVA software programs. Computer software programs are typically executed within the context of one or more compatible runtime environments. In certain embodiments, MA1 120 may preferably be implemented in a manner that avoids specifically defining such a runtime environment. Instead, MA1 120 may preferably be implemented as one or more libraries that may be directly invoked by appropriate entities in a corresponding host computer 114. In certain embodiments, MA1 120 may preferably adhere to a JAVA 2 Enterprise Edition (J2EE) specification for application server technology, and MA1 120 may thus be readily embeddable in computers 114 that are compliant with the J2EE specification. One exemplary configuration and corresponding functionalities for computers 114(a) and 114(b) are further discussed below in conjunction with FIG. 2.

Referring now to FIG. 1B, a block diagram of an electronic network 112 is shown, in accordance with one embodiment of the present invention. In the FIG. 1B embodiment, electronic network 112 may preferably include, but is not limited to, a computer A 114(a) and a computer B 114(b). In alternate embodiments, electronic network 112 may readily be implemented using various components and configurations in addition to, or instead of, those discussed in conjunction with the FIG. 1B embodiment. For example, electronic network 112 may include any number of computers 114 that are connected in any desired manner.

During the operation of the FIG. 1B embodiment, a first trading partner may preferably utilize computer A 114(a) to bi-directionally exchange electronic messages directly with a second trading partner through path 122 to computer B 114(b) in a peer-to-peer communication procedure. For example, an application A 118(a) of computer A 114(a) may preferably prepare and send messages through a local marketsite application integrator (MAI) 120(a) directly to computer B 114(b) via path 122. In response, computer B 114(b) may preferably utilize a local MA1 120(b) to receive the messages sent from computer A 114(a), and provide the messages to an application B 118(b) for appropriate action.

Similarly, an application B 118(b) of computer B 114(b) may preferably prepare and send messages through MA1 120(b) directly to computer A 114(a) via path 122. In response, computer A 114(a) may preferably utilize MA1 120(a) to receive the messages sent from computer B 114(b), and provide the 5 received messages to application A 118(a) for appropriate action. One exemplary configuration and corresponding functionalities for computers 114(a) and 114(b) are further discussed below in conjunction with FIG. 2.

Referring now to FIG. 2, a block diagram for one embodiment of the FIGS. 1A and 1B computers 114 is shown, in accordance with the present invention. In the FIG. 2 embodiment, computer 114 preferably may include, but is not limited to, a central processing unit (CPU) 212, a display 216, a memory 220, and one or more input/output interface(s) (I/O interface(s)) 224. The foregoing components of computer 114 may preferably be coupled to, and communicate through, a system bus 228. In alternate embodiments, computer 114 may readily be implemented using various components and configurations in addition to, or instead of, those discussed in conjunction with the FIG. 2 embodiment. In addition, computer 114 may be implemented as part of any desired type of electronic system or device.

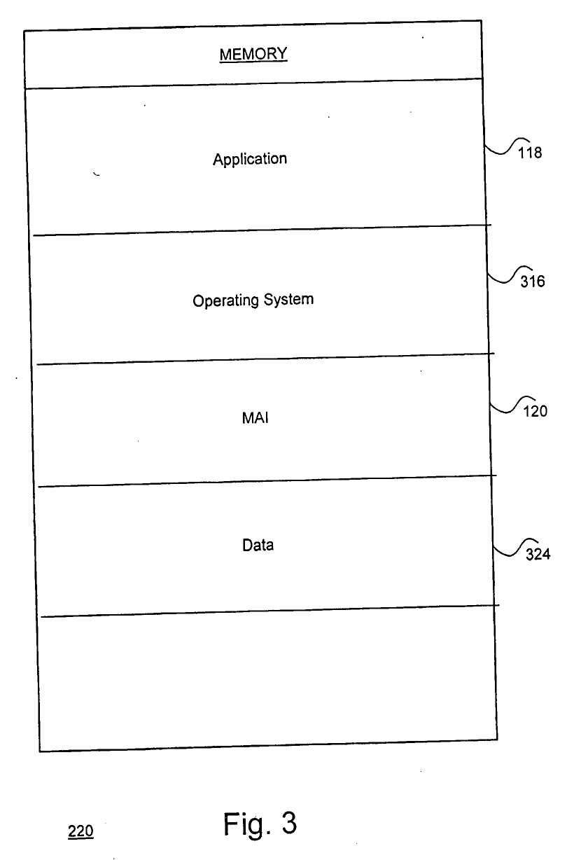

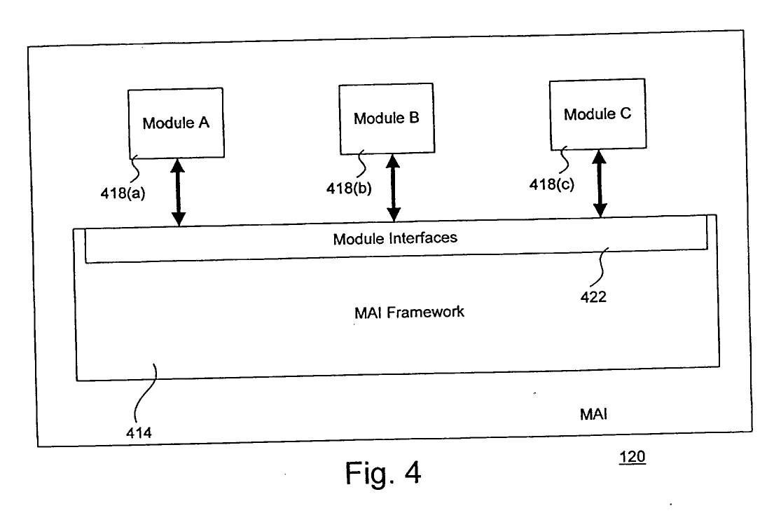

In the FIG. 2 embodiment, CPU 212 may be implemented to include any appropriate and compatible microprocessor device that preferably executes software instructions to thereby control and manage the operation of computer 114. The FIG. 2 display 216 preferably may include any effective type of display technology including a cathode-ray-tube monitor or a liquid-crystal display device. In the FIG. 2 embodiment, memory 220 may be implemented to include any combination of desired storage devices, including, but not limited to, read-only memory (ROM), random-access memory (RAM), and various types of non-volatile memory, such as floppy disks or hard disks. The contents and functionality of memory 220 are further discussed below in conjunction with FIGS. 3 and 4.

In the FIG. 2 embodiment, 1/0 interface(s) 224 may preferably include one or more input and/or output interfaces to receive and/or transmit any required types of information by computer 114. 1/0 interface(s) 224 may include one or more user interfaces to allow a system user to communicate with computer 114. For example, the foregoing user interfaces may support a keyboard device, a wireless remote control device, a speech-recognition module with corresponding microphone, a graphical user interface with touch-screen capability, or a selection button array mounted externally on computer 114.

Referring now to FIG. 3, a block diagram for one embodiment of the FIG. 2 memory 220 is shown, in accordance with the present invention. In the FIG. 3 embodiment, memory 220 preferably includes, but is not limited to, an application 118, an operating system 3 16, a marketplace application integrator (MAI) 120, and data 324. In alternate embodiments, memory 220 may readily include various other components in addition to, or instead of, those components discussed in conjunction with the FIG. 3 embodiment.

In the FIG. 3 embodiment, application 312 may include program instructions that are preferably executed by CPU 212 (FIG. 2) to perform various functions and operations for computer 114. The particular nature and functionality of application 312 preferably varies depending upon factors such as the specific type and particular use of the corresponding computer 114. For example, in certain embodiments, application 118 may preferably manage various electronic commercial transactions with other entities in electronic network 110 (FIG. 1A) or electronic network 112 (FIG. 1B). In the FIG. 3 embodiment, operating system 316 may preferably control and coordinate low-level functionality of computer 114.

In accordance with the present invention, computer 114 may preferably utilize marketsite application integrator (MAI) 120 for advantageously performing various information management procedures to thereby facilitate communications between computer 114 and other appropriate entities. In alternate embodiments, MA1 120 may readily be implemented in various types of electronic devices other than computer 114. The implementation and utilization of MA1 120 is further discussed below in conjunction with FIG. 4 through 12. In the FIG. 3 embodiment, data 324 may preferably include any desired type of electronic information for use by computer 114.

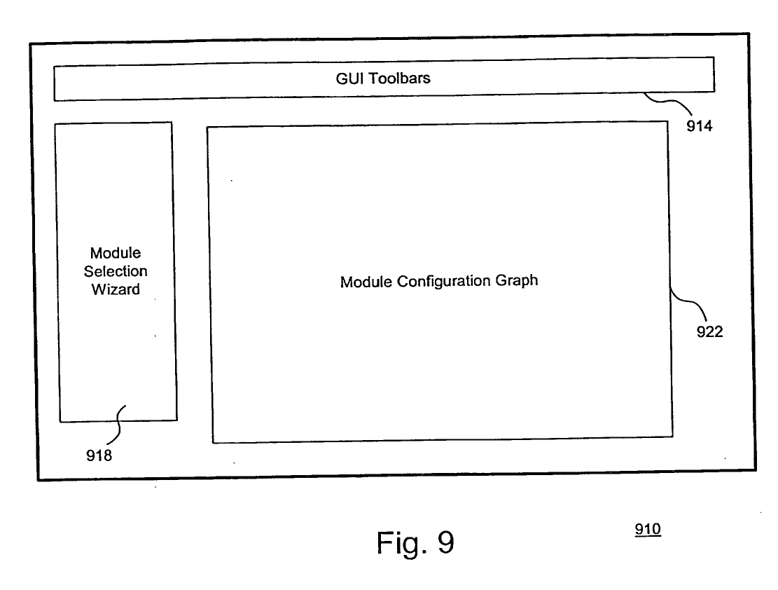

Referring now to FIG. 4, a block diagram for one embodiment of the FIG. 3 MA1 120 is shown, in accordance with the present invention. In the FIG. 4 embodiment, MA1 120 may include, but is not limited to, a series of modules 418, module interfaces 422, and an MA1 framework 414. In alternate embodiments, MA1 120 may readily include various other components in addition to, or instead of, those components discussed in conjunction with the FIG. 4 embodiment. In addition, for purposes of illustration, the FIG. 4 embodiment depicts a module A 418(a), a module B 418(b), and a module C 418(c). However, in alternate embodiments, MA1 120 may readily include a substantially larger number of modules 418, as further discussed below in conjunction with FIG. 9.

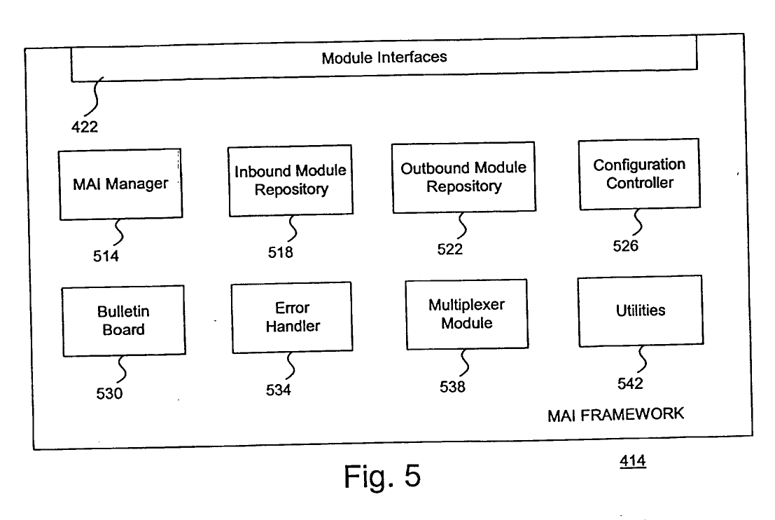

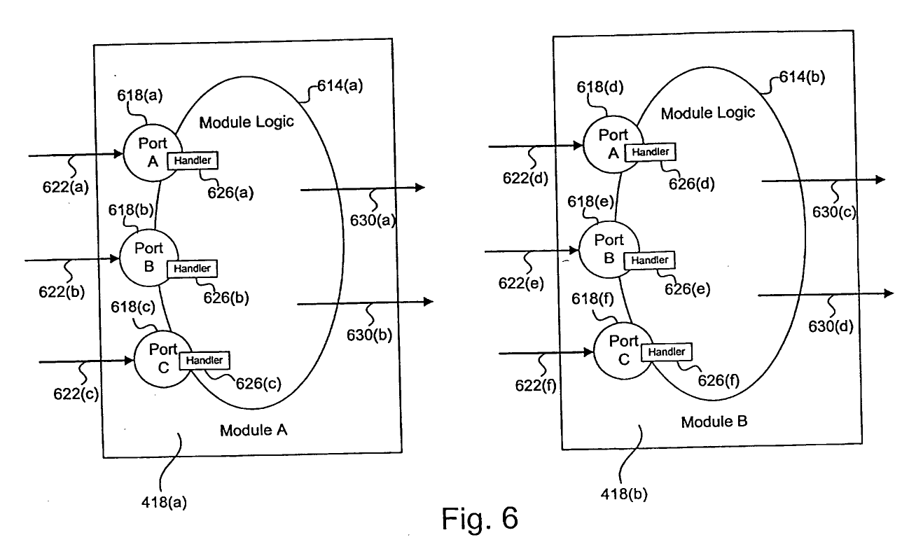

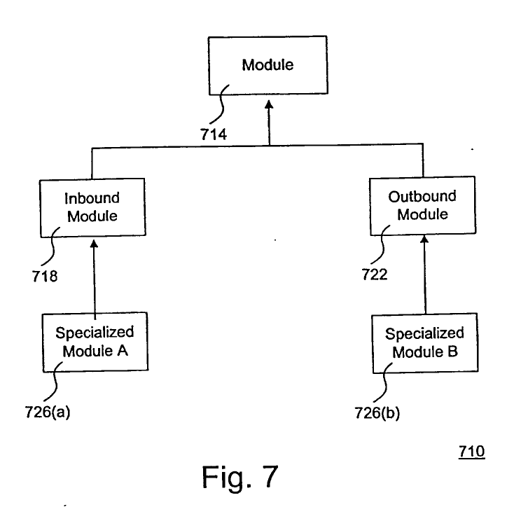

In the FIG. 4 embodiment, modules 418 may each plug into MA1 framework 414 through appropriate module interfaces 422. One embodiment for module interfaces 422 is further discussed below in conjunction with FIG. 7. In addition, a message transfer procedure for modules 418 is discussed below in conjunction with FIG. 6. Furthermore, one embodiment for MA1 framework 414 is discussed below in conjunction with FIG. 5.

In the FIG. 4 embodiment, MA1 120 is disclosed and discussed as being implemented as a group of software modules that are executed by CPU 212 (FIG. 2). However, in alternate embodiments, various portions of MA1 120 may readily be implemented as appropriate electronic hardware circuits or devices that are configured for performing particular functions that are equivalent to those functions discussed herein in conjunction with the operations of MA1 120.

Referring now to FIG. 5, a block diagram for one embodiment of the FIG. 4 MA1 framework 414 is shown, in accordance with the present invention. In the FIG. embodiment, MA1 framework 414 may include, but is not limited to, a MA1 manager 514, an inbound module repository 518, an outbound module repository 522, a configuration controller 526, a bulletin board 530, an error handler 534, a multiplexer module 538, and utilities 542. In alternate embodiments, MA1 framework 414 may readily be implemented using various components and configurations in addition to, or instead of, those discussed in conjunction with the FIG. 5 embodiment.

In the FIG. 5 embodiment, MA1 manager 514 may preferably manage startup procedures and shutdown procedures for MA1 120. For example, MA1 manager 514 may initialize various elements of MA1 120 during a startup procedure, and may similarly perform various system cleanup functions during a shutdown procedure. In the FIG. 5 embodiment, inbound module repository 518 may preferably include appropriate inbound modules 418 for receiving messages from entities that are external to computer 114. Conversely, in the FIG. 5 embodiment, outbound module repository 522 may preferably include appropriate outbound modules 418 for transmitting messages to entities that may or may not be external to computer 114.

In the FIG. 5 embodiment, configuration controller 526 may preferably control the configuration of modules 418 for MA1 120. For example, a system user may preferably utilize configuration controller 526 to flexibly configure modules 418 to thereby create a customized inbound module pipeline or a customized outbound module pipeline. In the FIG. 5 embodiment, bulletin board 530 may preferably be utilized by various entities to post and retrieve relevant information regarding the operation of MA1 120.

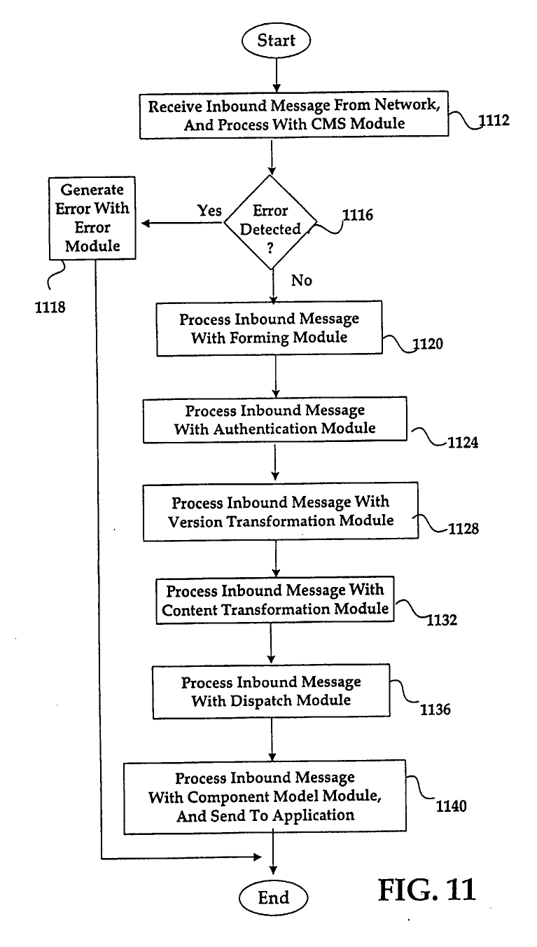

In the FIG. 5 embodiment, error handler 534 may preferably support various exception hierarchies and error message generation for MA1 120. In the FIG. 5 embodiment, multiplexer module 538 may preferably perform message multiplexing functions for inbound or outbound messages, as further discussed below in conjunction with FIG. 11. In the FIG. 5 embodiment, utilities 542 may preferably provide appropriate programming tools for use with MA1 120.

Referring now to FIG. 6, a block diagram illustrating a message transfer procedure for the FIG. 4 modules 418 is shown, in accordance with the present invention. In alternate embodiments, modules 418 may readily perform message transfer procedures using various components and techniques in addition to, or instead of, those discussed in conjunction with the FIG. 6 embodiment.

In the FIG. 6 embodiment, module logic 614 of modules 418 may preferably receive a message at a given port 618 via a corresponding path 622. Messages handled by MA1 120 may preferably be formatted and structured in any desired manner. For example, in certain embodiments, a message may preferably include a message header with various relevant 1 information related to that particular message. In addition, a message may also preferably include message data (or “payload”) that includes any desired information that is transported by that particular message. In certain embodiments, MA1 120 may preferably be compatible with various messages that are formatted in accordance with an electronic business Extensible Markup Language (ebXML) or with other appropriate message formats.

In the FIG. 6 embodiment, module logic 614 may be implemented to perform any desired functionality for a corresponding module 418. In the FIG. 6 embodiment, modules 418 are each shown with three ports (port A, port B, and port C). However, in alternate embodiments, modules 418 may 20 readily be implemented to include any number of ports 618. The utilization of multiple ports advantageously allows a module 418 to flexibly perform multiple functions.

In addition, in the FIG. 6 embodiment, each port 618 may preferably be associated with at least one corresponding handler 626. In certain embodiments, a given port 618 may readily be associated with multiple handlers 626. In cases where a given module 418 handles inbound messages, a corresponding handler 626 may be designated as a “listener”. Conversely, in cases where a given module 418 handles outbound messages, a corresponding handler 626 may be designated as a “transmitter”. In the FIG. 6 embodiment, modules 418 also each include two output paths 630 that may transfer a message from module logic 614 to one or more predetermined downstream modules 418. In alternate embodiments, modules 418 may be implemented to include any desired number of output paths.

In the FIG. 6 embodiment, during an exemplary message transfer procedure, module logic 614(a) of module A 418(a) may preferably handle a given message according to the designated functionality of module A 418(a). Module A 418(a) may then preferably reference a local pointer (not shown) that specifically identifies the next module 418(b) in the configurable module pipeline of MA1 120. In the FIG. 6 embodiment, the local pointer may preferably also indicate the designated port on the next module 418(b). For purposes of illustration, assume that the designated port for the current exemplary message transfer procedure is port A 618(d) of module B 418(b).

Module A 418(a) may then preferably request a handler 626(d) from the designated port A 618(d) of the next module 418(b). In response, module B 418(b) may preferably send handler 626(d) to module A 418(a) to receive the message and transfer the received message to port A 618(d) of module B 418(b) for appropriate action by module logic 614(b). In accordance with the foregoing message transfer procedure, modules 418 may thus directly and sequentially handle and transfer messages through the module pipeline in an efficient manner without intervention by other entities.

Referring now to FIG. 7, a block diagram 710 for one embodiment of the FIG. 4 module interfaces 422 is shown, in accordance with the present invention. In alternate embodiments, module interfaces 422 may readily be implemented using various configurations and techniques in addition to, or instead of, those discussed in conjunction with the FIG. 7 embodiment.

In the FIG. 7 embodiment, module interfaces 422 are represented in accordance with a Unified Modeling Language (UML) notation in which a particular interface is represented by a corresponding block. In the FIG. 7 embodiment, module interfaces 422 may preferably include a top-level interface called module 714 and two secondary-level interfaces called inbound module 718 and outbound module 722. Each module interface 422 may preferably include one or more Application Program Interfaces (APIs) that may also be referred to herein as “contracts”.

The FIG. 7 embodiment also includes a specialized module A 726(a) and a specialized module B 726(b) that are examples of customized modules 418 that may be created to perform one or more specialized functions for MA1 120. In the FIG. 7 embodiment, subject to certain constraints dictated by the contracts of higher-level module interfaces 422, specialized modules 726 may be flexibly created by system users of computer 114 to advantageously plug into the module pipeline of MA1 120. In other words, customized modules 418 may be developed to plug into MA1 120 by implementing the contracts of the corresponding higher-level interfaces. For example, a developer may thus write specialized module A 726(a) as a class that is forced to implement the methods/functions that module 714 and inbound module 718 declare. In certain embodiments, MA1 120 may also include a separate higher-level interface called “configurable module” that may provide functionality for configuring modules 418 in MA1 120.

In certain embodiments, main module 714 may preferably include, but is not limited to, the following API methods.

1). getModuleId: This method is an accessor method for the corresponding module's unique identifier (module ID). The module ID must be unique through the MA1 deployment environment. Each module 418 should define its own default module ID which may be overwritten if multiple instances of the same module are deployed.

2). setModuleId: This method is a mutator method for the module's unique identifier (module ID). The module ID must be unique through the MA1—deployment—environment. Each module 418 should define its own default module ID which may be overwritten if multiple instances of the same module are deployed. The implementation of getModule Id should recursively invoke the related method, setModule Id, on each Moduleport object that the corresponding module 418 aggregates.

3). setNextModule: This method is a mutator method for the next module 418 in the module pipeline, and preferably returns the next module ID.

4). getNextModule: This method is an accessor method for the next module 418 in the module pipeline, and preferably returns the next module.

5). getport: This method preferably returns the Moduleport object associated with the specified port ID.

6). ports: This method returns a list of ports 618 supported by the corresponding module 418.

7). isEnabled: This method corresponds to a boolean flag that indicates whether the corresponding module 418 is currently processing new messages.

8). enable: This method enables (or re-enables) processing of messages. This method only enables a particular module 418, independent of the next module in the module pipeline.

9). enableRecursive: This method enables (or re-enables) processing of messages. This method enables a particular module 418 as well as the next module in the module pipeline.

10). disable: This method temporarily disables processing of messages. This method only disables a particular module 418, independent of the next module in the module pipeline.

11). disableRecursive: This method temporarily disables processing of messages. This method disables a particular module 418 as well as the next module in the module pipeline.

12). close: This method permanently disables processing of messages and releases all resources. This method only closes a particular module 418, independent of the next module in the module pipeline.

13). closeRecursive: This method permanently disables processing of messages and releases all resources. This method closes a particular module 418 as well as the next module in the module pipeline.

In addition, in certain embodiments, inbound module 718 of FIG. 7 may preferably include, but is not limited to, a getMessageListener method that is the primary factory method for MessageListener objects. Similarly, outbound module 722 of FIG. 7 may preferably include, but is not limited to, a getMessageTransmitter method that is the primary factory method for MessageTransmitter objects.

In certain embodiments, various additional module interfaces 422 may also be utilized. For example, a ModulePort interface may preferably be implemented to support various ports 618 (FIG. 6) from a particular 10 module 418. The ModulePort interface may preferably include a getModuleId method that may preferably act as an accessor method for an identifier (ID) of the module 418 to which the corresponding port 618 belongs. The ModulePort interface may also include a getPortId method that preferably acts as an accessor for an ID of the corresponding port 618.

Furthermore, in certain embodiments, a MessageListener interface and a MessageTransmitter interface may be implemented to support respective handlers 626 (FIG. 6). The MessageListener interface may preferably include an onSyncMessage to handle synchronous messages. A reply transmitter agent 626 may then preferably be provided when a synchronous message arrives. The MessageListener interface may also include an onMessage method for handling asynchronous messages that do not require a response in the same execution thread. The MessageTransmitter interface may preferably include a send method that dispatches messages from a given MA1 120, and may also include a sendAndReceive method that dispatches messages from a given MA1 120, and then waits for a response message.

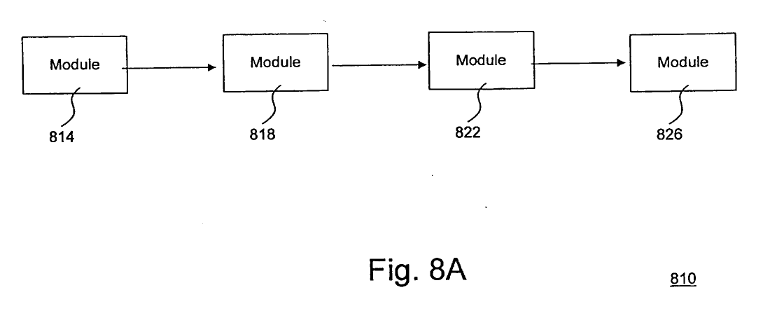

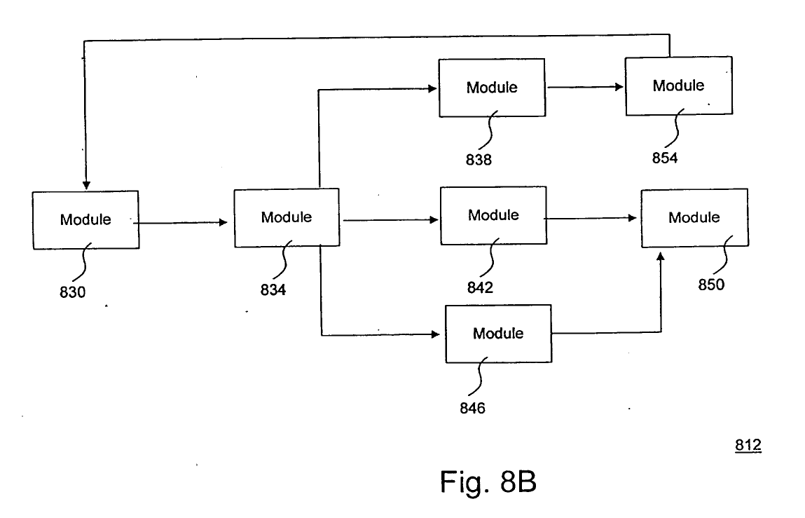

Referring now to FIG. 8A, a block diagram for one embodiment of a 30 linear module pipeline 810 is shown, in accordance with the present invention. In alternate embodiments, linear module pipelines may readily be implemented using various components and configurations in addition to, or instead of, those discussed in conjunction with the FIG. 8A embodiment.

In the FIG. 8A embodiment, an initial module 814 may preferably receive an inbound message or an outbound message from a corresponding message source, and may then responsively handle the message appropriately. Module 814 may then transfer the message to module 818 using any appropriate techniques. For example, module 814 (and other modules of FIG. 8A) may utilizes techniques that are the same or similar to those discussed above in conjunction with FIG. 6.

In the FIG. 8A embodiment, module 818 may preferably handle the message appropriately, and may then transfer the message to module 822. Similarly, module 822 may handle the message, and may then transfer the message to module 826 which may responsively handle the message and transfer the message to an appropriate destination. In accordance with the FIG. 8A linear module pipeline, the FIG. 8A embodiment may thus handle and propagate messages in a linear manner that proceeds sequentially from one module to another subsequent module.

Referring now to FIG. 8B, a block diagram for one embodiment of a non-linear module pipeline 812 is shown, in accordance with the present invention. The FIG. 8B non-linear module pipeline 812 is presented for purposes of illustration, and in alternate embodiments, non-linear module pipelines may readily be implemented using various components and configurations in addition to, or instead of, those discussed in conjunction with the FIG. 8B embodiment.

In the FIG. 8B embodiment, an initial module 830 may preferably receive an inbound message or an outbound message from an appropriate message source, and may then responsively handle the message in accordance with the functionality of the particular module. Module 830 may then transfer the message to module 834 using any appropriate techniques. For example, module 830 (and other modules of FIG. 8B) may utilizes techniques that are the same or similar to those discussed above in conjunction with FIG. 6.

In the FIG. 8B embodiment, module 834 may handle the message appropriately, and may then separately transfer the message (or components of the message) to module 838, module 842, and module 846 in a non-linear manner. A single module (such as module 834) may thus provide message information to any desired number of other modules in MA1 120.

Module 838 may handle its respective message, and may then transfer the message to module 854 which may preferably handle the message and transfer the message back to module 830 by means of a feedback loop. In addition, module 842 may handle its respective message, and may then transfer the message to module 850 which may preferably handle the message and transfer the message to an appropriate destination.

Similarly, module 846 may handle its respective message, and may then also transfer that message to module 850 which preferably may handle the message and transfer the message to an appropriate destination. A single module (such as module 850) may thus receive message information from any desired number of other modules in MA1 120. In accordance with the FIG. 8B non-linear module pipeline, the FIG. 8B embodiment may thus handle and propagate information in a non-linear manner that may be configured to include any effective paths, patterns, or configurations.

Referring now to FIG. 9, a block diagram for one embodiment of a configuration graphical user interface (GUI) 910 is shown, in accordance with the present invention. In the FIG. 9 embodiment, configuration GUI 910 may include, but is not limited to, GUI toolbars 914 module selection wizard 918, and a module configuration graph 922. In alternate embodiments, configuration GUI 910 may readily be implemented using various components, configurations, and formats in addition to, or instead of, those discussed in conjunction with the FIG. 9 embodiment.

In addition, GUI 910 may be utilized in any appropriate manner to effectively perform a module pipeline configuration procedure. For example, GUI 910 may be displayed upon display 216 of computer 114 (FIG. 21, and user input may be provided through a keyboard or mouse supported by I/O interfaces 224 (FIG. 2). In the FIG. 9 embodiment, the display and utilization of GUI 910 may preferably be controlled by a configurator manager program that may preferably be executed by CPU 212 of computer 114 (FIG. 2).

In the FIG. 9 embodiment, GUI toolbars 914 may preferably include any desired items for effectively utilizing GUI 910. For example, GUI toolbars 914 may include appropriate information fields, ikons, pulldown menus, and various selection buttons for utilizing GUI 910. In the FIG. 9 embodiment, GUI toolbars 914 may preferably include an inbound button and an outbound button (not shown) for performing respective module pipeline configuration procedures for either an inbound module pipeline or an outbound module pipeline of MA1 120.

In the FIG. 9 embodiment, module selection wizard 918 may preferably be utilized by a system user to flexibly perform the foregoing module configuration procedures. For example, a system user may activate module selection wizard 918, and may then interactively input various types of relevant information to thereby allow module selection wizard 918 to optimally configure an appropriate module pipeline for MA1 120.

In the FIG. 9 embodiment, a representation of the current module pipeline configuration may be displayed on module configuration graph 922 for ready viewing and editing by the system user. For example, in certain embodiments of GUI 910, a system user may perform a module pipeline editing procedure by utilizing appropriate input devices, such as a keyboard or a mouse, to select and position certain modules in the current module pipeline configuration. In addition, in certain embodiments, a module palette (not shown) may display module ikons that represent locally-available modules for utilization in the module configuration procedure of MA1 120. A system user may then preferably select and insert any desired modules from the foregoing module palette into the current module configuration shown in module configuration graph 922 to thereby flexibly configure the module pipeline of MA1 120.

In the FIG. 9 embodiment, a system user may also perform an individual module configuration procedure by selecting a given module 418 shown on module configuration graph 922 as part of the current module pipeline configuration. A module 418 may be selected for the foregoing individual module configuration procedure by utilizing any effective technique. For example, a system user may double-click on a selected module 418 in module configuration graph 922 by utilizing a mouse or other input device to initiate the foregoing module configuration procedure.

During the foregoing individual module configuration procedure a module configuration GUI (not shown) may preferably be generated to permit a system user to advantageously configure various characteristics of the selected module 418 by utilizing any appropriate techniques. For example, the module configuration GUI may provide various fields, ikons, buttons, and menus for specifying user preferences and functionalities for the selected module 418.

In certain embodiments, MA1 120 may preferably also support an installer GUI (not shown) that may be utilized by a system user during an installation procedure for installing MA1 120 in a given environment, such as computer 114 (FIG. 2). In addition, MA1 120 may preferably also support an administrator GUI (not shown) that may be utilized by a system user to perform ongoing day-to-day management of MA1 120. The foregoing installer GUI and administrator GUI may be implemented to include any appropriate and effective elements or components for performing their respective designated functionalities.

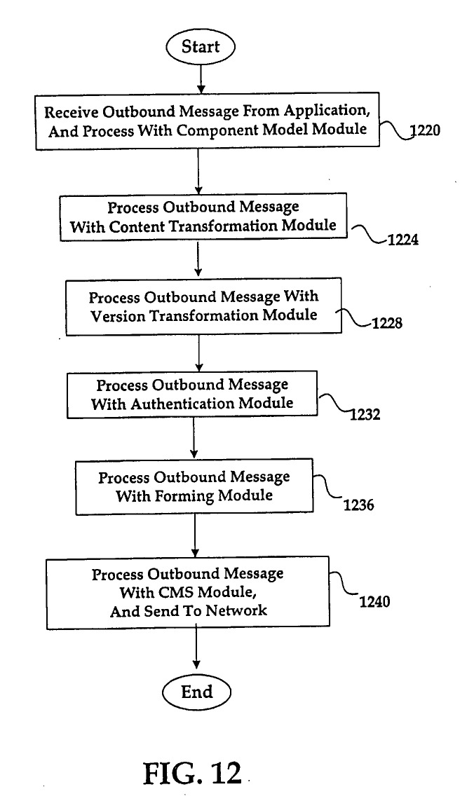

In the FIG. 9 embodiment, a system user may utilize module configuration graph 922 to selectively display either a default inbound configuration or a default outbound configuration for the module pipeline of MA1 120. One embodiment for the utilization of a default inbound module pipeline is further discussed below in conjunction with FIG. 11. Similarly, one embodiment for the utilization of a default outbound module pipeline is further discussed below in conjunction with FIG. 12.

In certain embodiments, the foregoing default inbound module pipeline may preferably include, but is not limited to, the following modules 418:

1). Connector Messaging Service (CMS) module: This module preferably receives messages from an external message source, such as electronic network 110, and may responsively perform various types of low-level loading and transport functions before guaranteeing that the received messages are successfully delivered to the next module 418 in the inbound module pipeline.

2). Multiplexer module 538: This module is a utility module (see FIG. 5) that preferably allows the delivery of messages to more than one module 418 in the inbound or outbound module pipeline. In the default inbound module pipeline, multiplexer module 538 may preferably deliver messages to a forming module unless an error condition occurs regarding a particular received message. If an error condition occurs, then multiplexer module 538 may preferably deliver the corresponding message to an error module.

3). Error module: This module preferably handles error conditions (such as when the CMS module is unable to recognize or handle a particular message), and may responsively generate error signals to the host system.

4). Forming module: This module preferably analyzes a message header and message data of a given message, and responsively performs a message introspection procedure to convert the received message into a formed message that is preferably restructured into a format that subsequent modules 418 and application 118 may easily recognize and handle. Several modules 418, including the forming module, may thus add layers of functionality to a received message in a multi-stage inbound message conversion process, so that application 118 may immediately handle a give message without further manipulation.

5). Authentication module: This module preferably performs an authentication procedure upon the formed messages to produce authenticated messages. For example, the authentication module may preferably verify the source of the formed message in relation to a message source identifier in the message header for security purposes.

6). Version transformation module: This module may preferably perform a format version transformation procedure upon authenticated messages whenever required to advantageously transform the authenticated messages into an appropriate format version that is compatible with application 118. As discussed above, several modules 418, including the version transformation module, may thus add layers of functionality to a received message in a multi-stage inbound message conversion process, so that application 118 may immediately handle a given message without further manipulation.

7). Content transformation module: This module may preferably perform a content transformation procedure upon authenticated messages (following version transformation) whenever required to advantageously transform content of the messages into an appropriate content format that is compatible with application 118. As discussed above, several modules 418, including the content transformation module, may thus add layers of functionality to a received message in a multi-stage inbound message conversion process, so that application 118 may immediately handle a give message without further manipulation.

8). Dispatch module: This module is a utility module that preferably receives an authenticated message (following version and content transformation), and responsively determines to which destination(s) the message should be dispatched, based upon certain predetermined rules and criteria.

9). Component model module: This module is a utility module that may preferably support functionality to separate a particular message into different message components to thereby provide greater granularity for subsequent usage by application 118.

In certain embodiments, a default outbound module pipeline may preferably include, but is not limited to, the following modules 418:

1). Component model module: This module is a utility module that preferably receives or detects a message from application 118 or other appropriate message sources, and responsively constructs the received message to be passed on to the next module in the outbound module pipeline.

2). Content transformation module: This module may preferably perform a content transformation procedure upon received messages to advantageously transform content of the messages into an appropriate content format that is compatible with an internal message format. In accordance with certain embodiments of the present invention, several modules 418, including the content transformation module, may thus add layers of functionality to a received message in a multi-stage outbound message conversion process, so that the MA1 120 and ultimately a particular message destination may immediately handle a give message without further manipulation.

3). Version transformation module: This module may preferably perform a format version transformation procedure upon messages (following content transformation) whenever required to advantageously transform the messages into an appropriate format version that is compatible with an internal message format. As discussed above, several modules 418, including the version transformation module, may thus add layers of functionality to a received message in a multi-stage outbound message conversion process, so that a particular message destination may immediately handle a give message without further manipulation.

4). Authentication module: This module preferably performs an authentication procedure upon messages (following content transformation and version transformation) to facilitate authenticated messages.

5). Forming module: This module preferably analyzes a message header and message data of a given message, and responsively performs a message forming procedure to convert an authenticated message into a generic message that is preferably restructured into a format that can be easily sent, for example, to the electronic network 110 of FIG. 1A. Several modules 418, including the forming module, may thus add layers of functionality to a given message in a multi-stage outbound message conversion process, so that an internal message format may immediately handle a give message without further manipulation.

6). Connector Messaging Service (CMS) module: This module preferably receives authenticated messages, and may responsively perform various types of low-level loading and transport functions before guaranteeing that the received messages are successfully delivered to a particular designated message destination.

In accordance with the present invention, MA1 120 may also offer any number of additional modules 418 in addition to, or instead of, those described above in conjunction with the default inbound module pipeline or the default outbound module pipeline. For example, MA1 120 may support such additional modules 418 as an inbound message archiver module that may preferably archive inbound messages, an outbound message archiver module that may preferably archive outbound messages, an inbound message decryptor module that may preferably decrypt inbound messages whenever necessary, and an outbound message encryptor module that may preferably encrypt outbound messages whenever necessary. MA1 120 may preferably also support any number of special modules that are customized to specifically perform various functions that are required by individual system users.

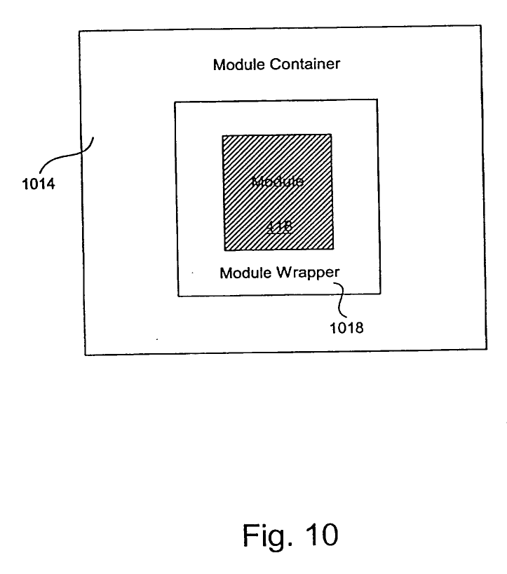

Referring now to FIG. 10, a block diagram illustrating a module wrapper 1018 is shown, in accordance with the present invention. In alternate embodiments, module wrapper 1018 may readily be implemented using various components and configurations in addition to, or instead of, those discussed in conjunction with the FIG. 10 embodiment.

In the FIG. 10 embodiment, MA1 120 may advantageously utilize module wrapper 1018 to embed a particular module 418 (including modules 418 of FIG. 5) into a module container 1014 of any desired format. In the FIG. 10 embodiment, the modules and module pipeline of MA1 120 may then be flexibly plugged into an appropriate module container 1014. For example, in certain embodiments, a selected module 418 may be deployed in an Enterprise Java Bean (EBJ) format by utilizing module wrapper 1018 to effectively embed the selected module 418 into a module container 1014 that is implemented as an EJB. In the FIG. 10 embodiment, module wrapper 1018 may thus be implemented as software code that acts as an interface to facilitate communications and provide compatibility between module container 1014 and module 418.

Furthermore, the present invention may advantageously support distributability of various components across a network. Distributability may preferably include the property of the present invention to “distribute” its components across a particular network instead of having all components execute on the same local computer. This technique may preferably allow better throughput, as well as more reliable and secure applications.

In certain embodiments, the distributability of some or all of MA1 120 may preferably be achieved by capitalizing on the Enterprise Java Beans (EJB) specification, and by making each module 418 deployable inside a separate EJB container. EJB may preferably enable effective development and deployment of distributed, transactional, secure, and portable Java applications. Developers of MA1 modules 418 need not be concerned about making their modules 418 distributable, because the MA1 framework preferably provides mechanisms and utilities to easily deploy modules 418 inside EBJ containers in a manner that is suitable to the particular business and technological environments of the system user.

In addition, certain embodiments of MA1 120 may also include various types of resource adapters for allowing MA1 120 to advantageously communicate with other substantially different technologies. These resource adapters may each preferably be implemented as software code that serves as a bridge between the environment of MA1 120 and the environment of any other desired technology. For example, in certain embodiments, MA1 120 may effectively and transparently communicate with a Java 2 Enterprise Edition Connector Architecture (J2EE CA) technology via an appropriate resource adapter.

Referring now to FIG. 11, a flowchart of method steps for performing a default inbound message procedure is shown, in accordance with one embodiment of the present invention. In the FIG. 11 embodiment, the various modules 418 that form an inbound module pipeline for performing the FIG. 11 default inbound message procedure may preferably be the same or similar to those discussed above in conjunction with FIG. 9. The FIG. 11 example is presented for purposes of illustration, and in alternate embodiments, the present invention may readily utilize various steps and sequences other than those discussed in conjunction with the FIG. 11 embodiment.

In the FIG. 11 embodiment, initially, in step 1112, a marketsite application integrator (MAI) 120 in a computer 114 may preferably receive an inbound message from any appropriate message source, and may responsively process the inbound message by utilizing a connector message service (CMS) module. For example, MA1 120 may receive an inbound message from a marketsite 126 in an electronic network 110 (FIG. 1A), or may alternately receive the inbound message directly from another computer 114(b) (FIG. 1B) in a peer-to-peer communication.

In step 1116, MA1 120 may preferably determine whether an error has been detected with regard to the foregoing inbound message. If an error has been detected, then a multiplexer module may preferably deliver the message to an error module, and in step 1118, the error module may preferably generate an error notification. The FIG. 11 process may preferably then terminate.

However, in foregoing step 1116, if MA1 120 does not detect an error with regard to the inbound message, then the multiplexer module may preferably deliver the inbound message to a forming module. In step 1120, MA1 120 may then preferably process the inbound message with the forming module, and may preferably provide the inbound message to an authentication module.

In the FIG. 11 embodiment, in step 1124, MA1 120 may preferably process the inbound message with the authentication module, and may then provide the inbound message to a version transformation module. Next, in step 1128, MA1 120 may preferably process the inbound message with the version transformation module, and may then provide the inbound message to a content transformation module. In step 1132, MA1 120 may preferably process the inbound message with the content transformation module, and may then provide the inbound message to a dispatch module.

In the FIG. 11 embodiment, in step 1136, MA1 120 may preferably process the inbound message with the dispatch module, and may then provide the inbound message to a component model module. Finally, in step 1140, MA1 120 may preferably process the inbound message with the component model module, and may then send the inbound message to application 118 of computer 114 for appropriate action. The FIG. 11 process may preferably then terminate.

Referring now to FIG. 12, a flowchart of method steps for performing a default outbound message procedure is shown, in accordance with one embodiment of the present invention. In the FIG. 12 embodiment, the various modules 418 that form an outbound module pipeline for performing the default outbound message procedure may preferably be the same or similar to those discussed above in conjunction with FIG. 9. The FIG. 12 example is presented for purposes of illustration, and in alternate embodiments, the present invention may readily utilize various other steps and sequences than those discussed in conjunction with the FIG. 12 embodiment.

In the FIG. 12 embodiment, initially, in step 1220, a marketsite application integrator (MAI) 120 in a computer 114 may preferably receive an outbound message from any appropriate message source, and may responsively process the outbound message by utilizing a component model module. For example, MA1 120 may receive an outbound message from an application 118 residing on computer 114. The component model module may then deliver the outbound message to a content transformation module in the default outbound module pipeline of MA1 120.

In step 1224, MA1 120 may preferably process the outbound message with the content transformation module, and may then provide the outbound message to a version transformation module. In step 1228, MA1 120 may preferably process the outbound message with the version transformation module, and may then provide the outbound message to an authentication module. Next, in step 1232, MA1 120 may preferably process the outbound message with the authentication module, and may then provide the outbound message to a forming module.

In the FIG. 12 embodiment, in step 1236, MA1 120 may preferably process the outbound message with the forming module, and may then provide the outbound message to a connector messaging service (CMS) module. Finally, in step 1240, MA1 120 may preferably process the outbound message with the CMS module, and may then send the outbound message to an appropriate message destination for appropriate action. For example, MA1 120 may send the outbound message to a marketsite 126 in an electronic network 110 (FIG. 1A), or may alternately send the outbound message directly to another computer 114(b) (FIG. 1B) in a peer-to-peer communication. The FIG. 12 process may preferably then terminate.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A method for structuring a module pipeline, comprising the steps of
providing a graphical configuration interface to a user, including manipulation, customization and connection tools, and a palette of available modules;
providing a workspace, displayed on a computer screen, for performing configuration functions;
selecting modules for inclusion in the pipeline and arranging the same on the workspace;
functionally connecting and relating the selected modules, employing the manipulation and connection tools;
customizing the modules by adding selected functionality provided by the customization tools; and
outputting the completed module pipeline.

2. The method of claim 1, wherein the module pipeline is a linear module pipeline.

3. The method of claim 1, wherein the module pipeline is a non-linear module pipeline.

4. The method of claim 1, wherein the palette of available modules includes modules selected from the group including: a connector messaging service module; multiplexer module; error module; forming module; authentication module; version transformation module; content transformation module; dispatch module; and component module.

5. A system for configuring a module pipeline in a client computer, comprising:
peripheral user interface devices, including a monitor, and at least one of a mouse and a keyboard;
configuration application means, including
graphical configuration tool means for manipulating, customizing and connecting modules;
module palette means containing available modules;
workspace means, displayed on a computer screen, for performing configuration functions;
selection means functionally operative with the workspace means and the tool means for connecting and arranging modules;
customization means for adding functionality to modules; and
output means for outputting the pipeline from the configuration application means.

6. The system of claim 5, wherein the available modules include connector messaging service module; multiplexer modules; error modules; forming modules; authentication modules; version transformation modules; content transformation modules; dispatch modules; and component modules.
